(19) United States
(12) Patent Application Publication
(10) Pub. No.: US 2010/0074542 A1
(43) Pub. Date: Mar. 25, 2010

(54) APPARATUS FOR DECODING CONTEXT ADAPTIVE VARIABLE LENGTH CODE AND TABLE SEARCH METHOD FOR DECODING CONTEXT ADAPTIVE VARIABLE LENGTH CODE

(75) Inventors: Jae Jin LEE, Chungbuk (KR); Moo Kyoung CHUNG, Daejeon (KR); Seung Hyun CHO, Daejeon (KR); Kyung Su KIM, Seoul (KR); Jun Young LEE, Busan (KR); Seong Mo PARK, Daejeon (KR); Nak Woong EUM, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/368,814

(22) Filed: Feb. 10, 2009

(30) Foreign Application Priority Data
Sep. 10, 2008 (KR) 10-2008-0089481

(51) Int. Cl. G06F 7/06; G06F 17/30

(52) U.S. Cl. 382/239; 382/246

(57) ABSTRACT

Provided are an apparatus for decoding a minimum memory access-based context adaptive variable length code (CAVLC) of the moving picture compression standard, H.264, and a table search method for decoding a context adaptive variable length code using the same. The apparatus for decoding a context adaptive variable length code may be useful to improve an overall decoding speed since the repeated memory accesses may be reduced to 2 cycles of memory accesses by reconstructing a context adaptive variable length code table of first decoding information (TrailingOnes) and second decoding information (TotalCoefficient) into 2-step tables and storing the reconstructed 2-step tables in advance and performing a table search to decode the first decoding information and the second decoding information, by using the information stored in the 2-step tables, depending on whether the remaining bits except for the number of leading zero are present in the inputted bit stream.

### CROSS-REFERENCE TO RELATED APPLICATIONS

This application claims the priority of Korean Patent Application No. 2008-89481 filed on Sep. 10, 2008, in the Korean Intellectual Property Office, the disclosure of which is incorporated herein by reference.

### BACKGROUND OF THE INVENTION

1. Field of the Invention

The present invention relates to an apparatus for decoding a context adaptive variable length code of the moving picture compression standard, H.264, and more particularly, to an apparatus for decoding a minimum memory access-based context adaptive variable length code (CAVLC), and a table search method for decoding a context adaptive variable length code.

2. Description of the Related Art

Moving picture compression standard, H.264, is a new standard for moving picture compression that has a narrower scope than MPEG-4 Visual and is designed primarily to support transporting rectangular video frames of efficient and robust coding. The H.264 compression standard has been estimated as one of the next-generation moving picture compression technologies all over the world since it is possible for the H.264 compression standard to enable significantly better compression and improved support for reliable transmission. With the incorporation of the H.264 compression standard with next-generation services such as satellite digital multimedia broadcasting (DMB) service, it is particularly expected that the H.264 compression standard is widely used in the field of its applications such as high-quality image compressions, image transfers on internet or cable modem, digital data broadcasting, next-generation mobile phone, etc.

H.264 encoding systems are mainly divided into a context adaptive variable length coding (hereinafter, referred to as ‘CAVLC’) system, and a context-based adaptive binary arithmetic coding (hereinafter, referred to as ‘CABAC’) system. In these years, the CAVLC system has been used in the H.264 baseline profile, and both of the CAVLC and CABAC systems have been used in the main profile.

A CAVLC decoding process is carried out dividedly in 3 steps: one step of calculating a ‘TrailingOnes’ value and a ‘TotalCoefficient’ value for a 4×4 block, another step of calculating a ‘Total_Zero’ value and the other step of computing a ‘Run-Before’ value to restore 4×4 block data that are present before the encoding process. This decoding process is basically based on the table search. That is to say, the code values of ‘TrailingOnes,’ ‘TotalCoefficient,’ ‘Total_Zero’ and ‘Run_Before’ are stored in the form of a variable length code (hereinafter, referred to as ‘VLC’) table as defined in the H.264 compression standard. In each step of the decoding process, a decoder reads bits that are encoded as much as length of a code word stored in the VLC table, and then reads the code values that have been stored in a pair with the length of the code word in the VLC Table to compare the read code values with the previously read, encoded bit value, followed by repeating these steps until the decoder finds a code word whose code value is exactly equivalent to the length of the code word.

In general, the CAVLC table search method includes: storing lengths and code values of bit strings of a CAVLC table in each array, and when the arrays for the lengths and code values of the bit strings are completely formed, determining a decoding coefficient by referring to lengths and code values, in the array, corresponding respectively to the bit strings included in the CAVLC table, and comparing the length and code value with those of an input bit stream.

However, the conventional decoding methods have problems in that a decoding speed may be slow due to the repeated memory accesses since the lengths and code values stored in the arrays are repeatedly referred until the decoder finds a bit string that is equivalent to the input bit stream.

### SUMMARY OF THE INVENTION

The present invention is designed to solve the problems of the prior art, and therefore it is an object of the present invention to provide an apparatus and table search method for decoding an adaptive variable length code of new first decoding information (TrailingOnes (T1s)) and second decoding information (TotalCoefficient (Tc)), which may minimize memory accesses to rapidly decode an adaptive variable length code.

Also, it is another object of the present invention to provide an apparatus and table search method for decoding an adaptive variable length code capable of decreasing a table size of the CAVLC table and reducing memory accesses to 2 cycles of the memory accesses by reconstructing the CAVLC table of the first decoding information (TrailingOnes (T1s)) and the second decoding information (TotalCoefficient (Tc)) according to the number of leading zero and the remaining code values except for the bit strings up to the leading zero.

According to an aspect of the present invention, there is provided a table search method for decoding a context adaptive variable length code. Here, the table search method includes: reconstructing a context adaptive variable length code table of first decoding information (TrailingOnes) and second decoding information (TotalCoefficient) into 2-step tables and storing the reconstructed 2-step tables in advance; and performing a table search to decode the first decoding information and the second decoding information, by using the information stored in the 2-step tables, depending on whether the remaining bits except for the number of leading zero are present in the inputted bit stream.

According to another aspect of the present invention, there is provided an apparatus for decoding a context adaptive variable length code including a controller reconstructing a context adaptive variable length code table of first decoding information (TrailingOnes) and second decoding information (TotalCoefficient) into 2-step tables; a shifter activated by the controller to perform a table search to decode the first decoding information and the second decoding information, by using the information stored in the 2-step tables, depending on whether the remaining bits except for the number of leading zero are present in the inputted bit stream; and a memory storing the context adaptive variable length code table and the reconstructed 2-step tables.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating an array representing a conventional CAVLC table used for a CAVLC table search.

FIG. 2 is a diagram illustrating a configuration of a decoding apparatus according to one exemplary embodiment of the present invention.

FIG. 3 is a diagram illustrating an index table reconstructed according to one exemplary embodiment of the present invention.

FIG. 4 is a diagram illustrating an address table reconstructed according to one exemplary embodiment of the present invention.

FIG. 5 is a diagram illustrating a table search operation to decode a context adaptive variable length code in the decoding apparatus according to one exemplary embodiment of the present invention.

### DETAILED DESCRIPTION OF THE PREFERRED EMBODIMENT

Hereinafter, exemplary embodiments of the present invention will now be described in detail with reference to the accompanying drawings. For the exemplary embodiments of the present invention, detailed descriptions of known functions and constructions that are related to the present invention are omitted for clarity when they are proven to make the gist of the present invention unnecessarily confusing.

In accordance with one exemplary embodiment of the present invention, a method for decoding a first decoding information (TrailingOnes (T1s)) and a second decoding information (TotalCoefficient (Tc)) in each of luma and chroma is described in detail, as follows. First of all, examples of a TrailingOnes and TotalCoefficient CAVLC table of the H.264 standard is described in brief for convenience’ sake.

The TrailingOnes and TotalCoefficient CAVLC table of the H.264 standard may be, for example, represented as in the following Table 1, and bit strings of luma (0≦nC<2, 2nC<4, 4≦nC<8) and chroma (nC==−1) may be set to correspond to TrailingOnes and TotalCoefficient values (code values). Here, the TrailingOnes and TotalCoefficient CAVLC table, which is reconstructed when the requirement of nC==−1 is satisfied, is for example represented as in the following Table 2.

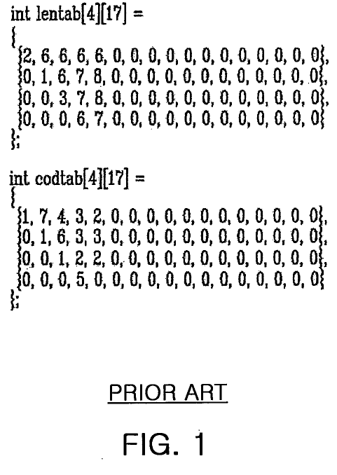

Lengths and code values of the bit strings included in the CAVLC table may be stored as in the matrixes of ‘lentab[4] [17]’ and ‘codtab[4] [17]’ of FIG. 1. In this case, a row index and a column index in each matrix correspond respectively to the TrailingOnes value and the TotalCoefficient value.

TABLE 1

| Trailing | Total | | | | | |
|---|---|---|---|---|---|---|
| Ones | Coeff | | | | | |
| (coeff_token) | (coff_token) | 0 ≦ nC < 2 | 2 ≦ nC < 4 | 4 ≦ nC < 8 | 8 ≦ nC | nC = 1 |
| 0 | 0 | 1 | 11 | 1111 | 0000 | 01 |
| | | | | | 11 | |
| 0 | 1 | 0001 01 | 0010 11 | 0011 11 | 0000 | 0001 11 |
| | | | | | 00 | |
| 1 | 1 | 01 | 10 | 1110 | 0000 | 1 |
| | | | | | 01 | |
| 0 | 2 | 0000 0111 | 0001 11 | 0010 11 | 0001 | 0001 00 |
| | | | | | 00 | |
| 1 | 2 | 0001 00 | 0011 1 | 0111 1 | 0001 | 0001 10 |
| | | | | | 01 | |
| 2 | 2 | 001 | 011 | 1101 | 0001 | 001 |
| | | | | | 10 | |
| 0 | 3 | 0000 0011 1 | 0000 111 | 0010 00 | 0010 | 0000 11 |
| | | | | | 00 | |
| 1 | 3 | 0000 0110 | 0010 10 | 0110 0 | 0010 | 0000 |
| | | | | | 01 | 011 |
| 2 | 3 | 0000 101 | 0010 01 | 0110 0 | 0010 | 0000 |
| | | | | | 10 | 010 |
| 3 | 3 | 0001 1 | 0101 | 1100 | 0010 | 0001 01 |
| | | | | | 11 | |
| 0 | 4 | 0000 0001 11 | 0000 0111 | 0001 | 0011 | 0000 10 |
| | | | | 111 | 00 | |
| 1 | 4 | 0000 0010 0 | 0001 10 | 0101 0 | 0011 | 0000 |
| | | | | | 01 | 0011 |
| 2 | 4 | 0000 0101 | 0001 01 | 0101 1 | 0011 | 0000 |
| | | | | | 10 | 0010 |
| 3 | 4 | 0000 11 | 0100 | 1011 | 0011 | 0000 |
| | | | | | 11 | 000 |
| 0 | 5 | 0000 0000 111 | 0000 0100 | 0001 | 0100 | — |
| | | | | 011 | 00 | |
| 1 | 5 | 0000 0001 10 | 0000 110 | 0100 0 | 0100 | — |
| | | | | | 01 | |
| 2 | 5 | 0000 0010 1 | 0000 101 | 0100 1 | 0100 | — |
| | | | | | 10 | |
| 3 | 5 | 0000 100 | 0011 0 | 1010 | 0100 | — |
| | | | | | 11 | |
| 0 | 6 | 0000 0000 0111 1 | 0000 0011 1 | 0001 | 0101 | — |
| | | | | 001 | 00 | |
| 1 | 6 | 0000 0000 110 | 0000 0110 | 0011 10 | 0101 | — |
| | | | | | 01 | |
| 2 | 6 | 0000 0001 01 | 0000 0101 | 0011 01 | 0101 | — |
| | | | | | 10 | |
| 3 | 6 | 0000 0100 | 00010 00 | 1001 | 0101 | — |
| | | | | | 11 | |
| 0 | 7 | 0000 0000 0101 1 | 0000 0001 | 0001 | 0110 | — |
| | | | 111 | 000 | 00 | |
| 1 | 7 | 0000 0000 0111 0 | 0000 0011 0 | 0010 10 | 0110 | — |
| | | | | | 01 | |
| 2 | 7 | 0000 0000 101 | 0000 00101 | 0010 01 | 0110 | — |
| | | | | | 10 | |
| 3 | 7 | 0000 0010 0 | 001 00 | 1000 | 0110 | — |
| | | | | | 11 | |
| 0 | 8 | 0000 0000 0100 0 | 0000 0001 | 0000 | 0111 | — |
| | | | 011 | 1111 | 00 | |
| 1 | 8 | 0000 0000 0101 0 | 0000 001 110 | 0001 | 0111 | — |
| | | | | 110 | 01 | |
| 2 | 8 | 0000 0000 0110 1 | 0000 001 101 | 0001 | 0111 | — |
| | | | | 101 | 10 | |
| 3 | 8 | 0000 0001 00 | 0000 100 | 0110 1 | 0111 | — |
| | | | | | 11 | |
| 0 | 9 | 0000 0000 0011 | 0000 0000 | 0000 | 1000 | — |
| | | 11 | 1111 | 1011 | 00 | |
| 1 | 9 | 0000 0000 0011 | 0000 0001 | 0000 | 1000 | — |
| | | 10 | 010 | 1110 | 01 | |
| 2 | 9 | 0000 0000 0100 1 | 0000 0001 | 0001 | 1000 | — |
| | | | 001 | 010 | 10 | |

TABLE 2

| | Trailing Ones | | | |
|---|---|---|---|---|
| Total Coefficient | 0 | 1 | 2 | 3 |
| 0 | 01 | — | — | — |
| 1 | 0001 11 | 1 | | |
| 2 | 0001 00 | 0001 10 | 001 | |
| 3 | 0000 11 | 0000 111 | 0000 010 | 0001 01 |
| 4 | 0000 10 | 0000 0011 | 0000 0010 | 0000 0000 |

Then, the decoding apparatus according to one exemplary embodiment of the present invention and the method for decoding a context adaptive variable length code using the same are described in more detail. Hereinafter, only a method for decoding TrailingOnes and TotalCoefficient values is described in the case of nC==−1 table (i.e. chroma) in accordance with one exemplary embodiment of the present invention. However, the TrailingOnes and TotalCoefficient values may be decoded in the case of 0≦nC<2, 2≦nC<4, 4≦nC<8 8≦nC table (i.e. luma) in the same manner as in the chroma. Therefore, detailed description of the luma decoding method is omitted for clarity in one exemplary embodiment of the present invention.

First, a configuration of the decoding apparatus for decoding a context adaptive variable length code is described in more detail with reference to the accompanying drawings.

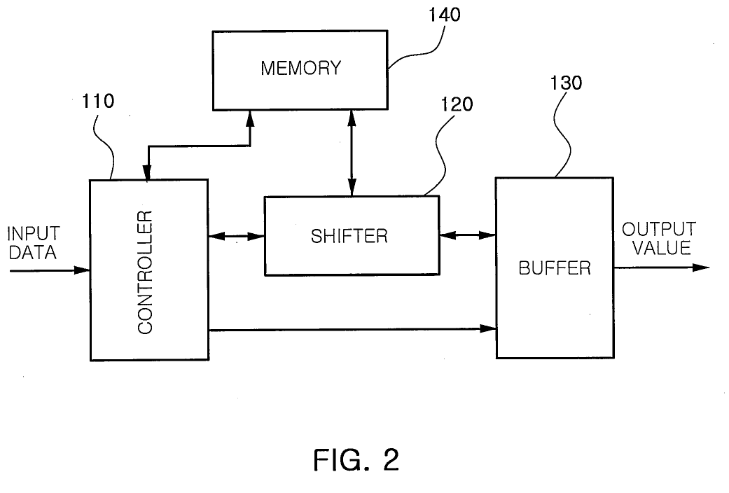

FIG. 2 is a diagram illustrating a configuration of a decoding apparatus according to one exemplary embodiment of the present invention.

Referring to FIG. 2, the decoding apparatus according to one exemplary embodiment of the present invention may comprise a controller 110, a shifter 120, a buffer 130 and a memory 140.

The controller 110 activates the shifter 120 to control a table search operation, stores input data required in the shifter 120, and controls the buffer 130 to output a bit stream of the data stored in the buffer 130. Also, the controller 110 reconstructs the table as pre-set in Table 2, depending on the number of leading zero, and then sets 2-step tables, that is, an index table (T1_Tc_chroma_index-table) and an address table (T1_Tc_chroma_vlc_table) in advance before a decoding process. These 2-step tables may be set by a program pre-set in the controller 110, but be set by allowing a user to directly set the 2-step tables and store the 2-step tables in a memory 140. Hereinafter, the setting the 2-step tables is operated in the controller 110.

The shifter 120 counts the number of 0, that is, the number of leading zero (Count Leading Zero: CLZ) until the shifter 120 meets the first code value of ‘1’ in the bit stream of the inputted data, transmits the number of the counted leading zero (0 bit) and data after the shifter 120 meets the first code value ‘1’, makes access to the memory 140 to perform 2 cycles of table searches, and decodes TrailingOnes and TotalCoefficient values by the 2 cycles of table searches.

The memory 140 stores the TrailingOnes and TotalCoefficient CAVLC table and the reconstructed 2-step tables (index table and address table).

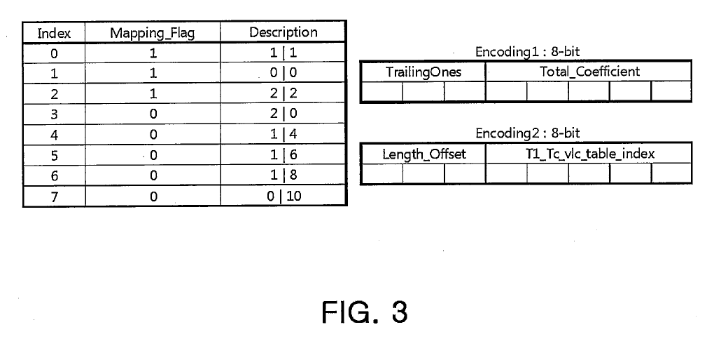

The index table reconstructed in advance and stored by the controller 110 is shown as in FIG. 3, and is composed of an index, a Mapping_Flag and a description.

The index value represents the number of leading zero, the Mapping_Flag is a flag that is composed of 1 bit to decode the leftmost description composed of 8 bits. The description includes TrailingOnes and TotalCoefficient values of a corresponding bit stream so as to complete the decoding of the corresponding bit stream by only one access to the memory 140. Here, the number of leading zero represents the continuous number of ‘0’ bit from the starting ‘0’ bit of the input bit stream. When the input bit stream is ‘0001 11,’ a CLZ value is 3, and when the input bit stream is ‘0000 000,’ a CLZ value is 7.

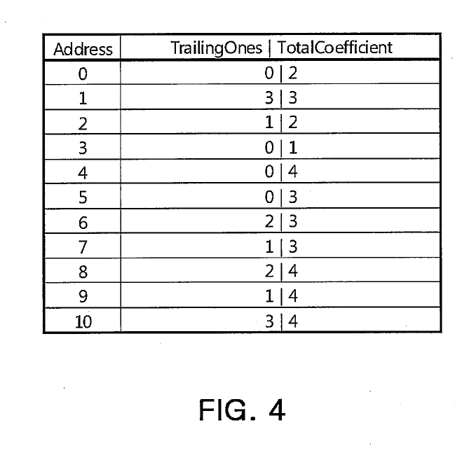

In order to construct the index table, the controller 110 sets an index according to the number of leading zero in the bit stream using the table as listed in Table 2. For example, when the input bit stream is ‘0001 11,’ the number of leading zero is allotted to 3, and therefore an index value becomes 3. Then, the controller 110 determines whether the continuous number (‘11’) is present in the bit stream corresponding to the index, and then sets a Mapping_Flag value to 0 when there is a continuous number in the bit stream and sets a Mapping_Flag value to 1 there is no continuous number in the bit stream. Therefore, the controller 110 sets a Mapping_Flag value to 0 when the input bit stream is ‘0001 11.’ Also, the controller 110 sets a description having 2 kinds of encoding information. Here, the set description uses first encoding (8-bit) information, as shown in FIG. 3, when the Mapping_Flag value is set to 1, and uses second encoding (8-bit) information, as shown in FIG. 3, when the Mapping_Flag value is set to 0. In this case, the first encoding information stores the TrailingOnes and TotalCoefficient values, and the second encoding information stores information (Length_Offset) on whether or not the controller 110 further reads the remaining bits next to the bit strings (CLZ+1) having the number of leading zero in the input bit stream, that is, the remaining bits except for the bit strings having the number of leading zero, and information (T1_Tc_vlc_table_index) required for computing an address value of the address table (T1_Tc_chroma_vlc_table). For example, the address table (T1_Tc_chroma_vlc_table) includes an address, and TrailingOnes and TotalCoefficient values corresponding to the address, as shown as in FIG. 4. The address table is pre-set by the controller 110. Here, the controller 110 determines the final address value of the address table by adding information (T1_Tc_vlc_table_index) required for computing a code value and an address value, and sets TrailingOnes and TotalCoefficient values corresponding to the determined address value. Here, the code value may be calculated from a bit value obtained by further reading as many bits as a ‘Lengh_Offset’ value next to the CLZ+1.

In the above-mentioned decoding apparatus, the shifter 120 should search the reconstructed 2-step table (index table and address table) to decode a context adaptive variable length code for decoding new TrailingOnes (T1s) and TotalCoefficient (Tc) for minimizing cycles of memory accesses using the reconstructed index table. Before this table search, the decoding apparatus reconstructs the 2-step tables and stores the reconstructed 2-step tables in the memory 140, as described above.

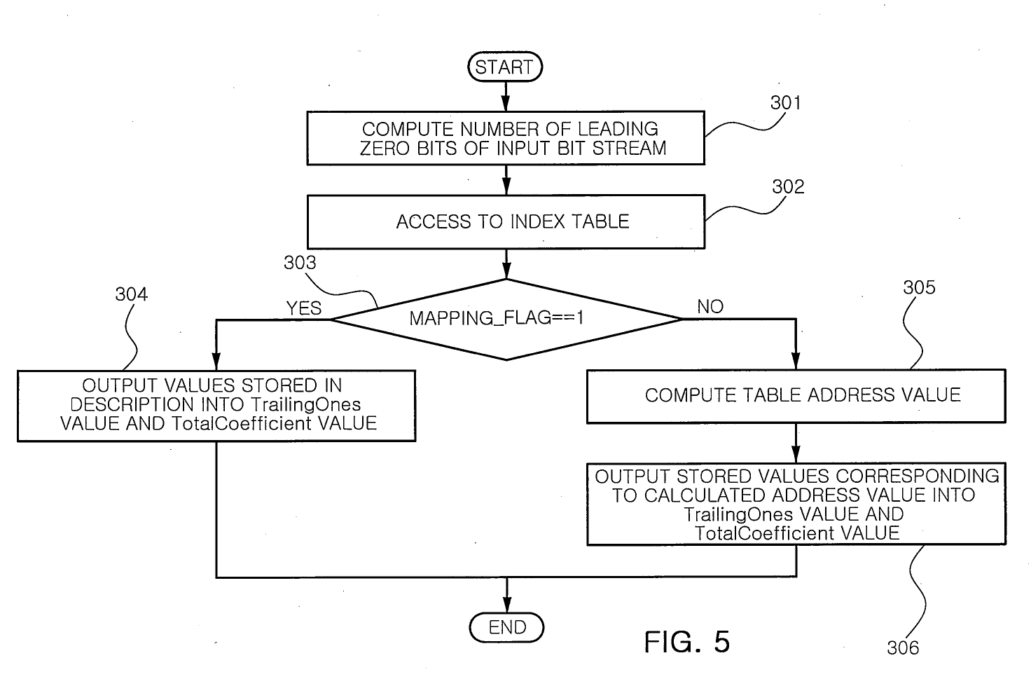

Then, the table search operation is described in more detail with reference to FIG. 5.

FIG. 5 is a diagram illustrating a table search operation to decode a context adaptive variable length code in the decoding apparatus according to one exemplary embodiment of the present invention.

Referring to FIG. 5, the decoding apparatus activates the shifter 120 under control of the controller 110, and then waits for an input of a bit stream. When the bit stream is inputted, the shifter 120 of the decoding apparatus counts the number of leading zero in the input bit stream (Operation 301). Then the shifter 120 uses the counted number of leading zero as indexes to access an index table stored in the memory 140 (Operation 302).

Next, the shifter 120 determines whether the Mapping_Flag value is 1 by checking a Mapping_Flag value of the index table (Operation 303). As a result, when the Mapping_Flag value is 1, the shifter 120 checks values stored in a description and outputs the stored values into TrailingOnes and TotalCoefficient values (Operation 304). For example, since the number of leading zero is 2 when the inputted bit stream is ‘001,’ the shifter 120 accesses index 2 of the index table, and therefore the Mapping_Flag value corresponding to the index 2 becomes 1. As a result, the shifter 120 outputs values, ‘2|2’, of kinds of the information stored in the first encoding information into the TrailingOnes and TotalCoefficient values, respectively.

On the contrary, when the Mapping_Flag value is 0, the shifter 120 calculates the final address value of the address table by adding the information stored in the description, that is, a code value and information (T1_Tc_vlc_table_index) required for computing an address value (Operation 305). Then, the shifter 120 makes another access to the memory 140 to output the stored values, which correspond to the computed address value in the address table as shown in FIG. 4, into TrailingOnes and TotalCoefficient values (Operation 306). For example, the number of leading zero becomes 3 when the input bit stream is ‘0001 10,’ the shifter 120 accesses index 3 of the index table, and therefore the Mapping_Flag value corresponding to the index 3 becomes 0. As a result, the shifter 120 checks that a ‘Lengh_Offset’ value of the encoding 2 information is 2, and the information (T1_Tc_vlc_table_index) required for computing the address value is 0 by checking the information stored in the description corresponding to the index 3. Since the ‘Lengh_Offset’ value is 2, the shifter 120 further reads 2 bits next to the CLZ+1, calculates a code value of the corresponding bits, and adds the calculated code value to a T1_Tc_vlc_table_index value of 0 to obtain an address value 2 (2(‘10’+0) of the address table. Finally, the shifter 120 outputs values ‘1|2’ stored in the calculated address value 2 into TrailingOnes and TotalCoefficient values, respectively.

As described above, even when there are any of bit streams, the decoding apparatus may decode a corresponding token, that is, TrailingOnes and TotalCoefficient CAVLCs, by performing a table search only by 2 cycles of memory accesses (worst case). As a result, the decoding apparatus may reduce a memory size by 69% or more, compared to the conventional decoding apparatuses.

In accordance with the exemplary embodiment of the present invention, the apparatus and table search method for decoding a context adaptive variable length code may be useful to improve an overall decoding speed, reduce power consumption, and decrease a memory size when compared to the conventional decoding apparatuses since the repeated memory accesses in the conventional table searches may be reduced to 2 cycles of memory accesses by reconstructing 2-step tables to perform a table search.

While the present invention has been shown and described in connection with the exemplary embodiments, it will be apparent to those skilled in the art that modifications and variations can be made without departing from the spirit and scope of the invention as defined by the appended claims.

What is claimed is:

1. A table search method for decoding a context adaptive variable length code, the table search method comprising:
reconstructing a context adaptive variable length code table of first decoding information (TrailingOnes) and second decoding information (TotalCoefficient) into 2-step tables and storing the reconstructed 2-step tables in advance; and
performing a table search to decode the first decoding information and the second decoding information, by using the information stored in the 2-step tables, depending on whether the remaining bits except for the number of leading zero are present in the inputted bit stream.

2. The table search method of claim 1, wherein the operation of reconstructing a context adaptive variable length code table into 2-step tables and storing the reconstructed 2-step tables in advance comprises:
setting an index table by using the number of leading zero of the bit streams stored in the context adaptive variable length code table and code values for the remaining bits of the stored bit streams except for the number of leading zero of the bit streams; and
setting an address table that store values for the first decoding information and the second decoding information corresponding to the computed address value by using the information stored in the index table.

3. The table search method of claim 2, wherein the operation of setting an index table comprises:
setting indexes to the number of leading zero of the stored bit stream;
setting a description having two kinds of encoding information; and
setting Mapping_Flag to decode the description, depending on whether the remaining bits are present in the stored bit stream.

4. The table search method of claim 3, wherein the description includes, as the encoding information, information on the remaining bits and information for computing the address value of the address table.

5. The table search method of claim 2, wherein the operation of setting an address table comprises:
setting an address; and
setting an address table including values for the first decoding information and the second decoding information that correspond to the address.

6. The table search method of claim 1, wherein the operation of performing a table search comprises:
counting the number of leading zero of the inputted bit streams;
accessing an index table that is one of the 2-step tables by using the number of the counted leading zero as indexes;
checking a Mapping_Flag value of the index table; and
outputting values of the first decoding information and the second decoding information, by using the information included in a description of the index table, depending on the checked Mapping_Flag value.

7. The table search method of claim 6, wherein the operation of outputting values of the first decoding information and the second decoding information comprises:
calculating an address value using encoding information included in the description of the index table when the Mapping_Flag value is 0; and
accessing the index table to output address values, which correspond to the calculated address value, into values of the first decoding information and the second decoding information.

8. The table search method of claim 6, wherein the operation of outputting values of the first decoding information and the second decoding information comprises: outputting the information included in the description of the index table into the values of the first decoding information and the second decoding information when the Mapping_Flag value is 1.

9. An apparatus for decoding a context adaptive variable length code, comprising:
a controller reconstructing a context adaptive variable length code table of first decoding information (TrailingOnes) and second decoding information (TotalCoefficient) into 2-step tables;
a shifter activated by the controller to perform a table search to decode the first decoding information and the second decoding information, by using the information stored in the 2-step tables, depending on whether the remaining bits except for the number of leading zero are present in the inputted bit stream; and
a memory storing the context adaptive variable length code table and the reconstructed 2-step tables.

10. The apparatus of claim 9, wherein the controller reconstructs an index table into one of the 2-step tables, the index table including an index set to the number of leading zero of the bit streams stored in the context adaptive variable length code table; a description having two kinds of encoding information; and Mapping_Flag for encoding the description.

11. The apparatus of claim 10, wherein the controller reconstructs an address table into one of the 2-step tables, the address table storing values of the first decoding information and the second decoding information corresponding to the computed address values by using the information stored in the index table.

12. The apparatus of claim 10, wherein the description includes, as the encoding information, information on the remaining bits except for bit strings having the number of leading zero of the stored bit stream, and information for computing an address value of the address table.

13. The apparatus of claim 9, wherein the shifter accesses an index table that is one of the 2-step tables by using the number of leading zero counted in the inputted bit stream as indexes, calculates an address value using encoding information included in the description of the index table when the Mapping_Flag value of the index table is 0, and accesses the index table to output address values, which correspond to the calculated address value, into values of the first decoding information and the second decoding information.

14. The apparatus of claim 13, wherein the shifter outputs the encoding information included in the description of the index table into the values of the first decoding information and the second decoding information when the Mapping_Flag value is 1.
